(19) United States
(12) Patent Application Publication
(10) Pub. No.: US 2008/0062120 A1
(43) Pub. Date: Mar. 13, 2008

(54) Location tracking system

(76) Inventors: Lorraine Wheeler, Billerica, MA (US); Rob Podoloff, Farmingham, MA (US); Michael Vosseller, Somerville, MA (US); Elaine Chen, Arlington, MA (US); Beth Marcus, Bedford, MA (US)

Correspondence Address: FISH & RICHARDSON, PC, P.O. BOX 1022, MINNEAPOLIS, MN, 55440-1022, US

(21) Appl. No.: 11/519,446

(22) Filed: Sep. 11, 2006

(51) Int. Cl. G09G 5/00

(52) U.S. Cl. 345/156

(57) ABSTRACT

A multi-range location tracking system for tracking a location of one or more objects, such as people, pets, or things, has one or more GPS-enabled accessory devices, with each accessory device being coupled to a corresponding one of the objects and being configured to generate location data of the corresponding object. The location tracking system also has a wireless link and one or more base units configured to communicate location data directly with the one or more accessory devices through the wireless link.

This application is related to co-pending U.S. patent application Ser. No. 11/249,009, filed on Sep. 6, 2005. The contents of the U.S. patent application Ser. No. 11/249,009 are incorporated in its entirety by reference. This application is also related to co-pending U.S. patent application Ser. No. 10/699,555, filed on Oct. 31, 2003 and co-pending U.S. patent application Ser. No. 11/221,412, filed on Sep. 6, 2005.

### BACKGROUND

The subject matter described herein relates to multi-range location tracking systems for tracking the location of people, pets, or things, and a method of providing such system.

Location-based services (LBS) are applications that leverage a user's physical location to provide an enhanced service or experience. LBS determine the location of the user by using one of several technologies for determining position, then use the location and other information to provide personalized applications and services. LBS typically answer three questions: “Where am I?”, “What's around me?”, and “How do I get there?”.

The support for LBS capability in mobile devices has permitted application developers to create compelling applications that are widely used and highly valued. But these applications tend to suffer from traditional mobile device user interface woes, such as difficulty in finding and launching the application, difficulty in navigating through the application menus, and difficulty in panning and zooming in and out of the field of view. Moreover, those applications that have more limited functionality and a better user interface typically lack some functions that would make them more useful. One interesting area of LBS applications are those used for locating a person or a pet. Generally, these LBS applications have been used with a cellular phone combined with a Global Positioning System (GPS) on board, an independent hand-held device with no cellular phone or GPS capability, and independent hand-held device with GPS or General Packet Radio Service (GPRS) capability.

In the case of cellular phone based solutions with GPS on board, the phone's location is polled from a web site or a remote server over a cellular network. The location of the cellular phone can then be displayed on a map shown on a web page on a computer. The location of the cellular phone can also be sent via instant text messaging to another phone. In the case of an independent device based solution with GPS capability as well as cellular coverage, this solution involves a separate GPS-equipped device with support for data uploads over-the-air on a cellular network using a data protocol such as GPRS (for GSM carriers) or EVDO (for CDMA carriers). Both the cellular phone based system and a dedicated GPS device with cellular coverage present significant limitations. First, an expensive subscription plan is usually required to activate the GPS tracking functionality, adding significantly to the cost of ownership and pricing some customers out of the available products. Second, the requirement for a cellular network makes the system less robust in areas with little or no cellular coverage, or in areas where high speed data rates are not achievable with existing cellular infrastructure.

Some of the independent GPS devices work with a personal computer, and others work with an additional, dedicated hand-held display used to present the GPS locations reported from the person or item being tracked. Dedicated GPS devices with cellular coverage suffer further from an increased cost of goods due to the need for complex expensive radio electronics that must comply with many standards from the FCC to operate over the cellular radio frequencies. For devices that require an additional, dedicated hand held display, the product architecture suffer further from the inconvenience of having to carry an additional device above and beyond electronic products that a consumer typically carries (e.g. mobile handset, iPod, headset), adding undesirable bulk to a mobile lifestyle. Lastly, unlike a mobile handset which typically goes everywhere with its owner, the hand-held locating device is likely to be forgotten when the end user is in a hurry. This limits the availability of the person or pet locating service to the end user.

There are GPS tracking devices which communicate via a base station with a radio frequency link other than cellular network coverage, to support data connectivity with a base station such as a personal computer. For these devices, the need for a separate receiver makes the device difficult to be implemented on a mobile phone platform.

In the case of an independent device based solution with no cellular phone or GPS capability, this solution typically helps a user locate a child or a pet by operating over a radio frequency communication link. This type of solution appears to work over a radio frequency link and basic triangulation may be used to deduce an approximate location of the child or pet. These devices offer low spatial resolution due to the lack of a GPS locator in the device. A child locator based on these systems typically only provides distance information and a small number of directions for the parent to follow. Furthermore, such a child locator is not capable of showing an accurate direction from the parent to the child, or overlaying this information with a map at an adequate level of spatial resolution that provides more information about how to find the child. This makes the device limiting in its ability to help the parent locate the child in an area where there is a lot of visual obstruction, such as within the aisles of a department store.

### SUMMARY

The present inventors recognized the deficiencies of existing GPS and non-GPS based tracking systems utilizing a cellular network or other types of wireless data connections. Consequently, the present inventors developed the subject matter described herein, which, for example, provides a multi-range LBS system that includes a GPS-enabled, miniature accessory device that communicates location data directly with a mobile phone or personal computer via a short-range wireless protocol such as Bluetooth or other wireless communication protocols, with an option to include long-range wireless coverage via a cellular network.

In one aspect, the multi-range location tracking system for tracking a location of one or more objects, such as people, pets, or things, has one or more GPS-enabled accessory devices, with each accessory device being coupled to a corresponding one of the objects and being configured to generate location data of the corresponding object. The location tracking system also has a wireless link and one or more base units configured to communicate location data directly with the one or more accessory devices through the wireless link.

Implementations may include one or more of the following features. For example, each of the base units may be configured to provide a user interface for interpreting and displaying the location data generated by the one or more accessory devices. The user interface may be configured to provide a compass-like functionality for determining the location of the one or more objects. The base unit may be a hand-held device operating on either a cellular network, a WiFi network (based on one of the IEEE 802.11 standards), or a WiMAX network (based on one of the IEEE 802.16 standards). The hand-held device may be a cellular phone, a smart phone, a pocket PC, a PDA, or a BlackBerry. Furthermore, the base unit may be a desktop computer equipped with a wireless transceiver or a laptop computer equipped with a wireless transceiver. The multi-range wireless link may be a Bluetooth connection, a WiFi connection, a WiMAX connection, or a radio frequency connection, or some other known multi-range wireless link. The base unit may also be configured to present an alert when the one or more objects to be tracked are outside of a predetermined or user-specified range. The base unit may be further configured to play a prerecorded warning message when the one or more objects are outside of a specified range. The GPS-enabled accessory device may also be configured to present an alert when the one or more objects to be tracked are outside of a predetermined or user-specified range.

In another aspect, the multi-range location tracking system may be implemented to provide a GPS navigational system by coupling a GPS-enabled accessory device to an end user. The accessory device is configured to generate location data of the end user and a base unit is configured to communicate directly with the accessory device through a multi-range wireless link. The base unit is further configured to provide a user interface for interpreting and displaying the location data generated by the accessory device.

In one variation, the base unit of the GPS navigation system may be further configured to communicate with a security provider through a subscription service. The base unit may be a hand-held device operating on one of a cellular network, a WiFi network, or a WiMAX network. The base unit may also be either a cellular phone, a smart phone, a pocket PC, a PDA, or a BlackBerry. The multi-range wireless link may be either a Bluetooth connection, a WiFi connection, a WiMAX connection, or a radio frequency connection, or some other known wireless link.

Computer program products, which may be embodied on computer readable-material, are also described. Such computer program products may include executable instructions that cause a computer system to conduct one or more of the method acts described herein. Similarly, computer systems are also described that may include one or more processors and a memory coupled to the one or more processors. The memory may encode one or more programs that cause the one or more processors to perform one or more of the method acts described herein.

These general and specific aspects may be implemented using a system, a method, or a computer program, or any combination of systems, methods, and computer programs.

The subject matter described herein may provide one or more of the following advantages. The multi-range LBS tracking system provides a low-cost, mass-adoptable, portable, and accurate locating device that can be used anywhere. In particular, the location accuracy of the multi-range LBS tracking system is better than what is currently offered by the non-GPS based location tracking products. Furthermore, it is much lower in cost than conventional systems requiring a GPS-enabled cellular phone, or standalone products with GPS built-in which must additionally support a long-range wireless link such as GPRS for connectivity with a base unit. With the disclosed subject matter, there is no fear that the tracking system would be disabled if the end user is in an area where cellular coverage is known to be minimal or non-existent. One or more implementations of the multi-range location tracking system include many of the features of conventional LBS products and can be produced in as an affordable add-on to existing cellular phones requiring no additional monthly fees and in a form factor which can be tailored to the desired object to be tracked.

Other aspects, features, and advantages will become apparent from the following detailed description, the drawings, and the claims.

### BRIEF DESCRIPTION OF THE DRAWINGS

FIG. 1 is a block diagram of the multi-range location tracking system.

FIGS. 2A-H illustrate GPS-enabled accessory devices in various form factors for use with various objects to be tracked.

FIG. 3 depicts one aspect of how the GPS-enabled accessory device communicates its location data directly with a cellular phone.

FIG. 4 shows an implementation of the multi-range LBS tracking system.

FIG. 5 shows another implementation of the multi-range LBS tracking system.

Like reference symbols in the various drawings indicate like elements.

### DETAILED DESCRIPTION

The subject matter described herein pertains to a multi-range LBS tracking system and a method of providing such a system by utilizing a GPS-enabled, miniature, battery-operated accessory device that communicates location data of one or more objects, such as people, pets or things, directly with a base unit via Bluetooth or other multi-range wireless link.

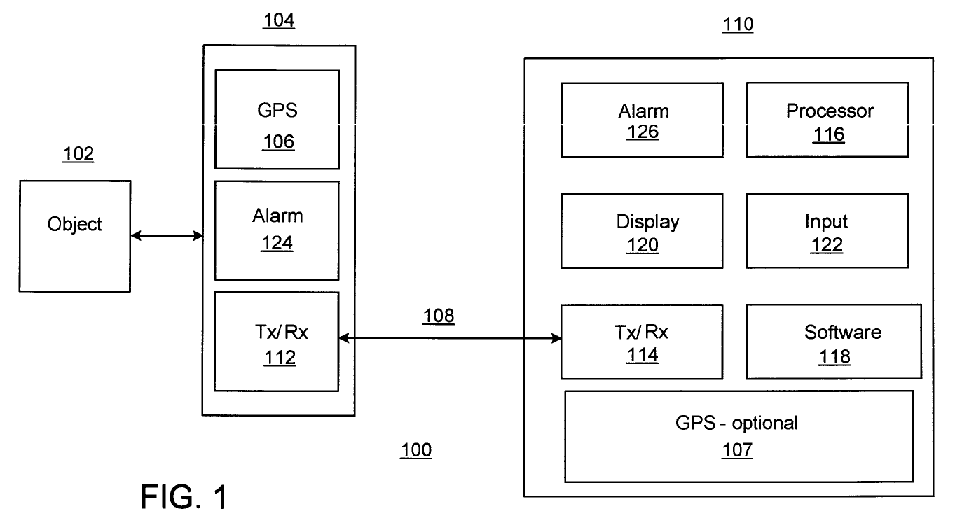

FIG. 1 is a schematic diagram of the multi-range LBS tracking system. The tracking system 100 is used to track the location of one or more objects 102. An accessory device 104 is coupled to the object 102 and has GPS capability 106 for generating location data of the corresponding object 102 to be tracked. The location data generated by the accessory device 104 is then communicated through a multi-range wireless link 108 directly to a base unit 110, such as a cellular phone, a personal digital assistant (PDA), a smart phone, a pocket PC, a Blackberry, a Palm Treo, a portable handheld computer, or a laptop or desktop computer. In one embodiment, the multi-range wireless link 108 may be a short range wireless link such as Bluetooth. The wireless communication between the accessory device 104 and the base unit 110 is made possible through a transceiver 112 embedded in the accessory device 104 and a transceiver 114 embedded in the base unit 110. The base unit 110 has one or more processors 116 capable of running a user interface application software 118. The base unit 110 may optionally include a GPS module 107 which can track the real time location of the base unit at all times—for example, if the base unit is a mobile device, the GPS module may be used to track its absolute position, thereby providing a way to track the relative position of the accessory device 104 relative to the location of the base unit 110. The GPS module 107 on the base unit 110 may be integrated in the product or may be implemented as an additional add-on accessory.

The user interface application software 118 is capable of interpreting the location data generated and transmitted by the accessory device 104 and showing the location data on a display module 120, such as a liquid crystal display (LCD). An end user may also enter information in the user interface application software 118 through an input module 122, such as a keypad. Additionally, the accessory device 104 has a built-in alarm 124 which will alert the object 102 to be tracked when the accessory device 104 is beyond a predetermined range from the base unit 110. Similarly, the base unit 110 also has a built-in alarm 126 to alert the end user that the object 102 to be tracked has gone beyond a predetermined range. The alarm can be presented with multi-modal options, including audio, visual and vibratory cues. Audio cues could take the form of a standard beep, chirp or pre-recorded message, or it could take the form of a ring tone or a part of a song, or it could be a message recorded by the user, or it may be customized in other ways by the user. Visual cues can be presented as flashing lights, flashing backlights and/or pop-up messages on the main screen. Vibratory feedback could be customized to have a few buzzing patterns to alert the parent/end user of different situations that may have come up.

In one embodiment, the wireless link 108 includes a short-range wireless connection such as Bluetooth. The Bluetooth protocol is a short-range, low-power 1 Mbit/sec wireless network technology operated in the 2.4 GHz band, which is appropriate for use in piconets. A piconet can have a master and up to seven slaves. The master transmits in even time slots, while slaves transmits in odd time slots. The devices in a piconet share a common communication data channel with total capacity of 1 Mbit/sec. Headers and handshaking information are used by Bluetooth devices to strike up a conversation and find each other to connect. In this embodiment, while the GPS-enabled accessory device 104 may not include long-range cellular connectivity (although it can be easily provided above and beyond the short-range wireless connectivity), it is equipped with a transceiver 112 operating over a short-range (for example, up to 300 meters) wireless link 108, which allows the GPS data reported by this device 104 to be transmitted directly to a base unit 110 that is equipped with a compatible short-range transceiver 114. The multi-range wireless link 108 of the location tracking system may be implemented in various ways. For example, the short-range portion of the multi-range wireless link 108 may be a Bluetooth connection between the base unit 110 and the accessory device 104. In another example, the short-range portion of the multi-range wireless link 108 may be provided by a radio frequency link not based on Bluetooth, which may result in better battery life preservation and longer operating range. In yet another example, the short-range portion of the multi-range wireless link 108 may be any one of the WiFi communications standards, based on the IEEE 802.11 specifications. In yet another example, the wireless link 108 may be a WiMAX communications standards, based on the IEEE 802.16 specifications.

The base unit 110, on the other hand, is a computing device that is in direct communication with the GPS-enabled accessory device 104. The based unit 110 receives the location data reported by the accessory device 104 , interprets the location data, and displays the location data through a rich user interface to the end user, while the on board software 118 is running on the phone at the discretion of the user.

The base unit 110 may be a mobile device operating on a cellular network. In another variation, the base unit 110 may be a PDA-type device, which may or may not be connected on the wireless network. The PDA device may be configured to interpret and display the location data from the GPS-enabled accessory device 104. In yet another variation, the base unit 110 may be a laptop computer or desktop computer that is equipped with a wireless transceiver 114 for multi-range wireless communications.

The base unit 110 may also know its own location—for example, it may be a stationary device such as a desktop computer whose location may be entered by the end user as a street address or a point of interest. The base unit 110 may also be a mobile device equipped with a GPS module 107 so that the mobile device can track both its own absolute location and the absolute and relative location of the accessory device 104 in relationship with the location of the base unit 110. Examples of these mobile base unit devices 110 may be cellular phones, PDAs, Blackberry, and Palm Treo. Information on the updated location of the base unit 110 allows the software running on the base unit 118 to show the relative location of the tracked person or object with respect to the location of the base unit.

The base unit 110 for the multi-range location tracking system is designed to meet the following requirements: (1) it supports multi-range wireless connectivity required by the GPS-enabled accessory device 104, including a short-range wireless connectivity link such as Bluetooth without reliance on the cellular network; (2) it enables a rich user interface to present data in a multimodal fashion, which may include text, images, videos, and sound; and (3) it enables a rich user interface to input data for adjusting settings, for example, setting the range at which an alert sounds on the base unit 110 should the accessory device 104 go out of range of the wireless link 108.

The software 118 for the base unit user interface may be downloaded to the base unit 110 via wireless or wired connectivity or it may be firmware embedded in the base unit 110. The user interface application software 118 for location tracking runs on the base unit 110, such as a mobile handset, so that it is always available to the owner of the mobile handset. The application software 118 may be delivered to the base unit 110 via any of the standard methods for application installation; for example, for a mobile handset, the application could be delivered over-the-air or by synchronizing with content loaded on a personal computer. Alternatively, the application for the location based software can come preloaded on the actual GPS location device 104 itself, and be delivered to the base unit 110 at the touch of a button over the same multi range radio link 108 that will be used for real time data communication during GPS tracking of the person, pet or object. A detailed description of this optional mechanism for delivering the software application 118 from the accessory device 104 to the base unit 110 via the wireless link 108 may be found in a co-pending application entitled “Mobile Content Delivery”, which is hereby incorporated in its entirety by reference.

One aspect of the multi-range location tracking system 100 allows a base unit 110 to communicate directly with one or more GPS-enabled accessory devices 104. The base unit 110 and the one or more accessory devices 104 work together as a multi-range location tracking system to allow the end user operating the base unit 110 to track the location of the one or more objects 102 to which each of the one or more accessory devices 104 is attached, as long as the device is within the range of the wireless link 108 between the accessory device 104 and the base unit 110. For example, if a parent desires to track the location of more than one child, each child may have his or her own GPS-enable accessory device 104, and the parent can rest assured that the location of all of her children are known at all times. In another example, an elementary school class may be led on a field trip by just a few teachers and parent helpers. The teacher in charge of the field trip may have a cellular phone functioning as a base unit 110, running the base unit user interface application 118, and each student may carry a GPS accessory device 104. The teachers and parent helpers may then keep track of the whole group in situations where they may be highly mobile and difficult to track.

Another aspect of the multi-range location tracking system 100 allows one GPS-enabled accessory device 104 to communicate directly with multiple base units 110. Since the accessory device 104 works over a multi-range wireless connection 108 such as Bluetooth with a standard command interface, the same device may also be used by police and other rescue workers to help find a lost child in an open area such as a national park or a forest. The accessory device 104 of the lost child can be “pinged” by multiple base units 110 which are in range, making it possible for a team of rescue workers to fan out over a large area, and to work on the same real time information to find the lost child. A child who is wearing a GPS-enabled accessory device 104 and who gets lost in the woods may be tracked by multiple rescue workers using the multi-range location tracking system 100 as they find their way towards the child. The multiple base units 110 carried by a number of rescue workers may optionally communicate with each other as well as with the GPS-enabled accessory device, supporting a high level of coordination between rescue workers. If the base units are equipped with GPS modules (107), the location of all parties can be tracked in real time. In another scenario, a class may be led on a field trip by teachers and parent helpers. Each student may carry a GPS accessory device 104. Each teacher and parent helper may carry a mobile device functioning as a base unit 110, running the base unit user interface application 118. The base units 110 may optionally communicate with each other as well as with the GPS accessory device. In this scenario, all the teachers and parent helpers can track all the students for the duration of the field trip.

Yet another aspect of the multi-range tracking system 100 allows the end user to specify a safety radius of the one or more objects 102 to be tracked. In this embodiment, the base unit 110 is either at a fixed location (e.g. a personal computer at a fixed address), or it can be a mobile device equipped with a GPS module 107, or it can be a mobile device with no GPS module 107, but its location is registered at the start of a tracking session by keeping the GPS accessory device 104 close to the base unit 110 and running initialization software to record the GPS location of the base unit 110 at that point in time, thereafter keeping the base unit 110 in a substantially fixed location while tracking the location of the GPS accessory device 104. By computing the distance between the two GPS read locations or the distance between a GPS location and an address entered on the base unit 110, a radius may be maintained between the base unit 110 and the device 104, and an alarm may be presented when the device starts to go out of range while still remaining in range for the multi-range wireless connection to function properly. For example, an alarm 114 on the base unit 110 can alert the parent when the child is moving away beyond a parent-specified safety radius. These alarms (124 and 126) can sound on the base unit 110 (e.g., the parent's cellular phone) and also on the accessory device 104 (e.g., the child's key fob). In one variation the alarm 114 may include pre-recorded messages, which may be played to a child. For example, the alarm message may be: “Stop walking, mommy needs to find you now!” In another variation, the alarm 114 may be custom messages recorded by the parent. In another variation, the alarm 114 may be a ring tone or a part of a song. In another variation, the alarm 114 may be multimodal in nature, providing options to include visual cues such as flashing LEDs on the base unit 110 (supported on some mobile handsets) or a flashing backlight on one or more displays on the mobile device used as a base unit 110. Vibratory cues can also be presented as an option for the alarm 114—the vibration on a mobile handset used as a base unit 110 can be programmed to present a few vibratory patterns to indicate different types of alerts to the parent discreetly without attracting attention from bystanders.

Further aspect of the multi-range location tracking system 100 allows multiple base units 110 to track the locations of each other through the multiple accessory devices 104 attached to the end users. This implementation may be useful in the case where there is a need for multiple people to keep track of the locations of each other at all times. For example, business professionals covering a very large trade show may each carry a cellular phone and a GPS-enabled accessory device 104, if their phone does not support GPS. Each person may view the locations of all of their coworkers on their own phones.

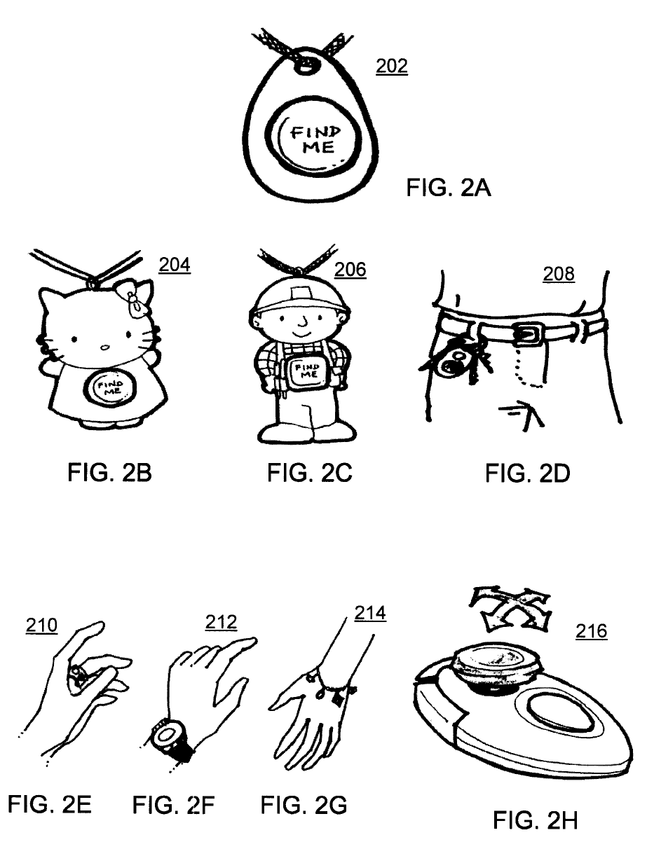

Referring to FIGS. 2A-H, the GPS-enabled accessory devices 104 may be implemented through a variety of form factors depending on the desired objects 102 to be tracked. For example, if the desired object 102 to be tracked is a child, the accessory device 104 may be designed to look like licensed characters 204, 206 or a toy to make it more fun to use for small children. The GPS-enabled accessory device 104 may take on the form factor of a space saving key fob 202, 208, or may be discreetly camouflaged as a fashion accessory, such as a ring 210, a watch 212, and a bracelet 214 for more mature users whose location need to be tracked by one or more base units 110. The accessory device 104 may even incorporate simple game or toy functions to ensure that the child keeps it with him/her. In addition, the accessory device 104 may be designed to have a very small form factor with simple controls. The controls may comprise as few as a single button for a product designed for a young child, or may encompass more buttons with specialized functions as well as one or more LEDs to indicate status to a more mature user such as a college student or a business professional. Alternatively, the device itself can have a custom input interface optimized for map navigation 216. In this scenario, the accessory device may be used in conjunction with a mobile handset operating as a base unit 110 to provide map navigation and/or turn-by-turn directions for the owner, as well as function as a person tracker and/or find-me type of tracking device. One example of a custom interface provides a means to present analog input signals to drive map navigation. For example, the cursor on a map may be driven with a two degree-of-freedom joystick, a touchstick, a touchpad, or a custom sensor constructed with multiple force-sensitive resistors. A detailed description of an optional mechanism for providing a custom input interface tailor-made to work well with a software application 108 may be found in the co-pending application entitled “Human Interface Input Acceleration System”, which is hereby incorporated in its entirety by reference.

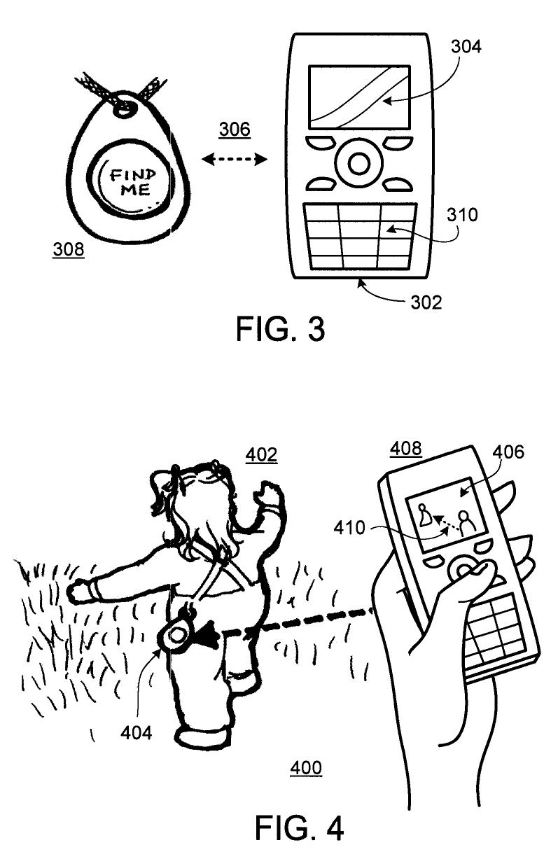

FIG. 3 shows the base unit 110 as a mobile device 302 operating on a cellular network, such as a GSM or WCDMA or CDMA2000 network. The base unit 302 may be a mobile handset running an application 304 which maintains the multi-range wireless link 306 with the accessory device 308. Furthermore, the end user can review and interact with the location-based data from the mobile handset through the input module 310, such as a keypad.

FIG. 4 shows an implementation of the multi-range tracking system 400 in which the location of a small child 402 is tracked within a large open area, such as a big park. The child 402 may be too young to follow instructions not to stray from her parents, so a GPS-enable accessory device 404 adds an additional level of security as the child 402 will not be lost simply because she strayed from or was occluded from the line of sight of the parent. Should the child lose sight of the parent, she can press the “Find me” button 202 to send an alert to the parent to join the child at her current location, as reported by the GPS accessory device 404.

Using the multi-range location tracking system 400, the parent may activate the child tracking application 406 on her mobile handset 408, and encourage the child 402 to enjoy the park. The parent may monitor the child's location on the mobile handset 408. When the child 402 strays beyond a range that has been pre-specified by the parent, an alert sounds both on the accessory device 404 carried by the child 402, and the mobile handset 408 carried by the parent. The parent may then switch to a compass mode 410 to locate the child with a simple interface that draws an arrow pointing from the parent's location to the child's location. The arrow will update interactively as the parent approaches the child 402. If available, a map of the local area (e.g. a park, family amusement center or some such location) may also be downloaded to the mobile handset 408 and optionally displayed on the phone together with the arrow as well as markers indicating the location of the mobile handset 408 and the accessory device 404. In one variation, electronic voice commands may be provided alone or in addition to the arrow and/or map of the local area which provide directions to the end-user. For example, the electronic voice commands may include “turn right” or “turn left” or “go straight” or some other direction command.

In the case of a lost child, using the GPS-enabled accessory device 104 attached to or carried by the child, and wirelessly linked to the parent or caregiver's cellular phone or personal computer, the parent or caregiver can rapidly find the child with the base unit user interface 118. In an embodiment where the base unit's location is known, either via manual entry or via GPS tracking or via synchronizing with the GPS tracker at the beginning of a tracking session, this interface may provide a compass-like functionality and point the parent to the right direction of the lost child, as well as display the distance of the parent to the child. A map overlay may be added to the base unit user interface to provide more detailed information on the immediate surroundings of the parent and the child, to better help the parent find the lost child.

The aspects of the multi-range location tracking system 100 are not limited to tracking the location of small children. Other implementations may be used where a person or a pet may not be able to find their own way. For example, elderly persons suffering from Alzheimer's disease, disabled persons suffering from conditions such as severe autism, congenital conditions affecting the intellect, brain injury, or other conditions which may reduce their spatial and/or language skills, or pets such as dogs running free in a park may all be kept safe and secure by wearing a GPS-enabled accessory device 104, which will allow their caregiver to monitor their location at all times and become alerted if they stray out of a safe range. Alternatively, the invention may be applied to a car-finder application, where the GPS accessory device 104 is left in a car and the software application 118 running on the base unit 110 may be used to help the driver of the car locate it within a large unmarked parking lot.

Another aspect of the multi-range location tracking system 100 allows the end users to track their own locations. This implementation may be useful where mobile device owners desire the capabilities of GPS but do not have GPS support on their mobile devices. While GPS is becoming more widespread, most mass market cellular phones in the US still do not support GPS today. With an implementation of the GPS-enabled accessory device 104 supporting Bluetooth as the multi-range wireless connection 108, anyone with a compatible cellular phone running the much more widespread Bluetooth protocol may quickly find their own location on a map. This aspect may further provide a highly cost effective way for end users to convert their cellular phones into GPS navigation systems.

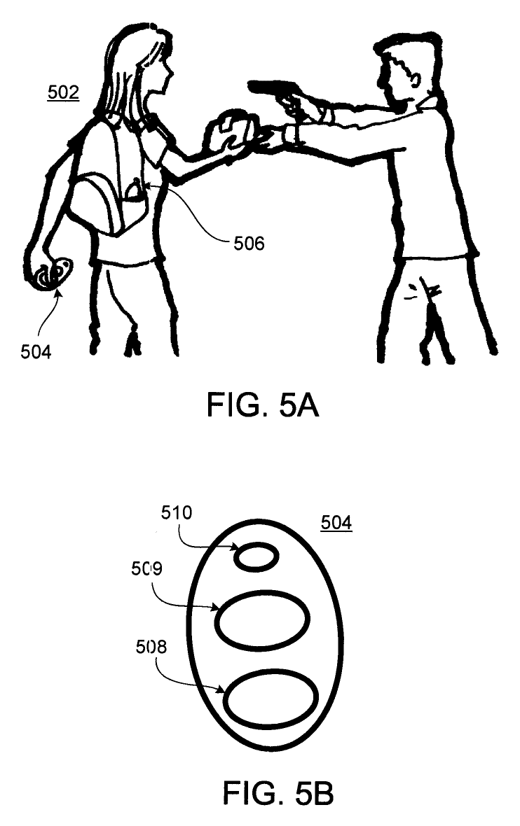

FIG. 5 illustrates how this type of “find-me” functionality may be extended to personal security. Imagine a college student 502 walking home at night. If the college student 502 has a GPS-enabled accessory devices 504 communicating with her mass market mobile handsets 506, the college student 502 may subscribe to a service like the OnStar system for cars, where an operator working for a security service provider or Campus Police may monitor the location of the student 502 at the discretion of the students. The student may press a button 509 to toggle whether the security service provider or Campus Police should monitor her location for a given period of time. If the student 502 gets into a challenging situation, the student 502 can press a button 508 on the accessory device 504 to immediately send a text message or another type of instant alert to the security service provider, which may include current location, so that help can be sent as quickly as possible. The device may optionally feature an LED 510 in the user interface. The LED status (on/off status, flashing frequency and/or color) can communicate the current status of the GPS accessory device 504 to the college student adequately without adding significant bulk to the device itself.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “information carrier” comprises a “computer-readable medium” that includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Although a few variations have been described in detail above, other modifications are possible. Accordingly, other implementations are within the scope of the following claims

What is claimed is:

1. A multi-range location tracking system for tracking a location of one or more objects, the system comprising:
one or more GPS-enabled accessory devices, each accessory device coupled to a corresponding one of the objects and configured to generate location data of the corresponding object;
one or more wireless links, at least one corresponding to a short-range wireless link; and
one or more base units configured to communicate location data directly with the one or more accessory devices through the wireless link.

2. The system of claim 1 wherein each of the base units is further configured to provide a user interface for interpreting and displaying the location data generated by the one or more accessory devices.

3. The system of claim 1 wherein at least one base unit is a hand-held device operating on one of a cellular network, a WiFi network, and a WiMAX network.

4. The system of claim 2 wherein at least one hand-held device is one of a cellular phone, a smart phone, a pocket PC, a PDA, and a BlackBerry.

5. The system of claim 1 wherein at least one base unit is one of a desktop computer equipped with a wireless transceiver or a laptop computer equipped with a wireless transceiver.

6. The system of claim 1 wherein the short-range wireless link is one selected from a group of a Bluetooth connection, a WiFi connection, and a short-range radio frequency connection.

7. The system of claim 1 wherein the one or more base units are further configured to present an alert when the one or more objects to be tracked are outside of a specified range.

8. The system of claim 1 wherein the one or more base units are further configured to play a prerecorded warning message when the one or more objects are outside of a specified range.

9. The system of claim 1 wherein the user interface is configured to provide a compass-like functionality for determining the location of the one or more objects.

10. The system of claim 1 wherein the one or more GPS-enabled accessory devices are further configured to present an alert when the one or more objects to be tracked are outside of a specified range.

11. A method of providing a multi-range location tracking system for tracking a location of one or more objects, the method comprising:
coupling one or more GPS-enabled accessory devices to a corresponding one of the objects, each accessory device configured to generate location data of the corresponding object; and
configuring one or more base units to communicate location data directly with the one or more accessory devices through one or more wireless links, at least one corresponding to a short-range wireless link.

12. The method of claim 11 wherein each of the base units is further configured to provide a user interface for interpreting and displaying the location data generated by the one or more accessory devices.

13. The method of claim 11 wherein at least one base unit is a hand-held device operating on one of a cellular network, a WiFi network, and a WiMAX network.

14. The method of claim 12 wherein at least one base unit is one selected from a group of a cellular phone, a smart phone, a pocket PC, a PDA, and a BlackBerry.

15. The method of claim 11 wherein at least one base unit is one of a desktop computer equipped with a wireless transceiver or a laptop computer equipped with a wireless transceiver.

16. The method of claim 11 wherein the short-range wireless links is one selected from a group of a Bluetooth connection, a WiFi connection, and a short-range radio frequency connection.

17. The method of claim 11 wherein the one or more base units are further configured to present an alert when the one or more objects are outside of a specified range.

18. The method of claim 11 wherein the one or more base units are further configured to play a prerecorded warning message when the one or more objects are outside of a specified range.

19. The method of claim 11 wherein the user interface is configured to provide a compass-like functionality for determining the location of the one or more objects.

20. The method of claim 11 wherein the GPS-enabled accessory devices are further configured to present an alert or play a prerecorded warning message when the one or more objects are outside of a specified range.

21. A method of providing a GPS navigational system using a multi-range location tracking system, the method comprising:
coupling a GPS-enabled accessory device to an end user, each accessory device configured to generate location data of the end user; and
configuring a base unit to communicate directly with the accessory device through one or more wireless links, at least one corresponding to a short-range wireless link;
wherein the base unit is further configured to provide a user interface for interpreting and displaying the location data generated by the accessory device.

22. The method of claim 21, wherein the base unit is further configured to communicate with a security provider through a subscription service.

23. The method of claim 21 wherein the base unit is a hand-held device operating on one of a cellular network, a WiFi network, and a WiMAX network.

24. The method of claim 22 wherein the base unit is one of a cellular phone, a smart phone, a pocket PC, a PDA, and a BlackBerry.

25. The method of claim 21 wherein the short-range wireless link is one of a Bluetooth connection, a WiFi connection, and a short-range radio frequency connection.
